(19) United States
(12) Patent Application Publication
(10) Pub. No.: US 2025/0187289 A1
(43) Pub. Date: Jun. 12, 2025

(54) SYSTEM AND METHOD FOR AUTOMATED PLACEMENT OF HANG TABS ON GIFT BAGS AND OTHER ITEMS

(71) Applicant: HALLMARK CARDS, INCORPORATED, KANSAS CITY, MO (US)

(72) Inventors: GERALD LITTLE, KANSAS CITY, MO (US); JACK GEORGE, KANSAS CITY, MO (US); ISAAC KITTLE, KANSAS CITY, MO (US)

(21) Appl. No.: 18/960,425

(22) Filed: Nov. 26, 2024

Related U.S. Application Data
(60) Provisional application No. 63/608,379, filed on Dec. 11, 2023.

(51) Int. Cl. B31B 70/81; B25J 15/06

(52) U.S. Cl. CPC B31B 70/81; B25J 15/0625; B25J 15/0666

(57) ABSTRACT

A system and method for automatically placing hang tabs on gift bags and other items. A hang tab applicator includes a rotary arm with a placement head. The rotary arm rotates between a first position, at which a hang tab is fed onto the placement head, and a second position, at which the placement head places the hang tab on an item during transport on a conveyor. A control system controls operation of the hang tab applicator so that rotation of the rotary arm is timed to cause accurate placement of the hang tab on the item. The hang tab may be placed on a gift bag at an offset position in which (i) an adhesive portion of the tab is attached to the bag and (ii) a hang hole portion of the hang tab extends away from the gift bag enabling it to be hung on a display hook.

### CROSS-REFERENCE TO RELATED APPLICATIONS

This application is based on and claims priority to U.S. Provisional Application Ser. No. 63/608,379, filed on Dec. 11, 2023, which is incorporated herein by reference in its entirety.

### BACKGROUND OF THE INVENTION

Gift bags often have a clear plastic hang tab that enables each bag to be hung on a display hook in a retail store for easy viewing by consumers. The hang tab includes an adhesive back that may be attached to a sidewall of the gift bag near the bag opening. A portion of the hang tab includes a hole or other cut-out that enables the gift bag to be hung on the display hook. While bag forming equipment may be used to automatically form the gift bags, such equipment is not capable of placing hang tabs on the bags. Rather, after the gift bags have been formed, a worker may be required to manually place a hang tab at the appropriate location on each individual bag. The cost of labor to manually place hang tabs on gift bags can be cost prohibitive.

### BRIEF SUMMARY OF THE INVENTION

The present invention is directed to a system and method for automatically placing hang tabs on gift bags and other items. In an exemplary embodiment, the hang tabs are placed on gift bags during the bag forming process. More specifically, before the gift bag is fully assembled and as it travels on a conveyor of bag forming equipment, a hang tab applicator feeds an adhesive-backed hang tab from a roll onto a placement head attached to a rotary arm. The rotary arm then rotates from a first feed position to a second placement position at which the placement head places the hang tab on the gift bag. Rotation of the rotary arm from the first feed position to the second placement position is timed to cause the placement head to place the hang tab on the gift bag at an offset position in which (i) an adhesive portion of the hang tab is attached to the gift bag and (ii) a hang hole portion of the hang tab extends away from the gift bag to enable the gift bag to be hung on a display hook. Integration of an automated hang tab placement system within the bag forming process eliminates the manual labor cost that would be incurred with a secondary process to place hang tabs on the gift bags. Of course, in other embodiments, the hang tab applicator may be used to place hang tabs at any desired location on different types of items.

Various embodiments of the present invention are described in detail below, or will be apparent to one skilled in the art based on the disclosure provided herein, or may be learned from the practice of the invention. It should be understood that the above brief summary of the invention is not intended to identify key features or essential components of the embodiments of the present invention, nor is it intended to be used as an aid in determining the scope of the claimed subject matter as set forth below.

### BRIEF DESCRIPTION OF THE DRAWINGS

A detailed description of various exemplary embodiments of the present invention is provided below with reference to the following drawings, in which:

FIG. 1A is a perspective view of a system for placing hang tabs on gift bags during transport on a conveyor in accordance with one embodiment of the invention;

FIG. 1B is a blown-up view of the portion of the hang tab applicator and conveyor shown as detail 1B in FIG. 1A.

FIG. 2A is a blown-up view of the portion of the hang tab applicator and conveyor shown as detail 2A in FIG. 1B showing the rotator plate of the hang tab applicator in a first feed position;

FIG. 2B is a blown-up view of the portion of the hang tab applicator and conveyor shown in FIG. 2A showing the rotator plate in an intermediate position;

FIG. 2C is a blown-up view of the portion of the hang tab applicator and conveyor shown in FIGS. 2A and 2B showing the rotator plate in a second placement position;

FIG. 3A is a rear-facing perspective view of the hang tab applicator shown in FIG. 1A;

FIG. 3B is a blown-up view of the portion of the hang tab applicator shown as detail 3B in FIG. 3A.

FIG. 4A is a perspective view of the rotary arm and placement head of the hang tab applicator shown in FIG. 1A;

FIG. 4B is a side elevation view thereof;

FIG. 4C is a front elevation view thereof;

FIG. 4D is a top plan view thereof;

FIG. 5 is a perspective view of the rotary union of the hang tab applicator shown in FIG. 1A;

FIG. 6 is a block diagram schematic showing one embodiment of a control system for controlling the hang tab applicator shown in FIG. 1A;

FIG. 7 is a process flow diagram showing one embodiment of a process for controlling the hang tab applicator using the control system shown in FIG. 6; and

FIG. 8 is a process flow diagram showing an exemplary process for timing the rotation of the rotary arm from a first feed position to a second placement position as part of the method shown in FIG. 7.

### DETAILED DESCRIPTION OF EXEMPLARY EMBODIMENTS

The present invention is directed to a system and method for automatically placing hang tabs on gift bags and other items. While the invention will be described in detail below with reference to various exemplary embodiments, it should be understood that the invention is not limited to the specific system configurations or methods of these embodiments. In addition, although the exemplary embodiments are described as embodying several different inventive features, one skilled in the art will appreciate that any one of these features could be implemented without the others in accordance with the invention.

In the present disclosure, references to “one embodiment,” “an embodiment,” “an exemplary embodiment,” or “embodiments” mean that the feature or features being described are included in at least one embodiment of the invention. Separate references to “one embodiment,” “an embodiment,” “an exemplary embodiment,” or “embodiments” in this disclosure do not necessarily refer to the same embodiment and are also not mutually exclusive unless so stated and/or except as will be readily apparent to one skilled in the art from the description. For example, a feature, structure, function, etc. described in one embodiment may also be included in other embodiments, but is not necessarily included. Thus, the present invention can include a variety of combinations and/or integrations of the embodiments described herein.

### Exemplary Hang Tab Placement System

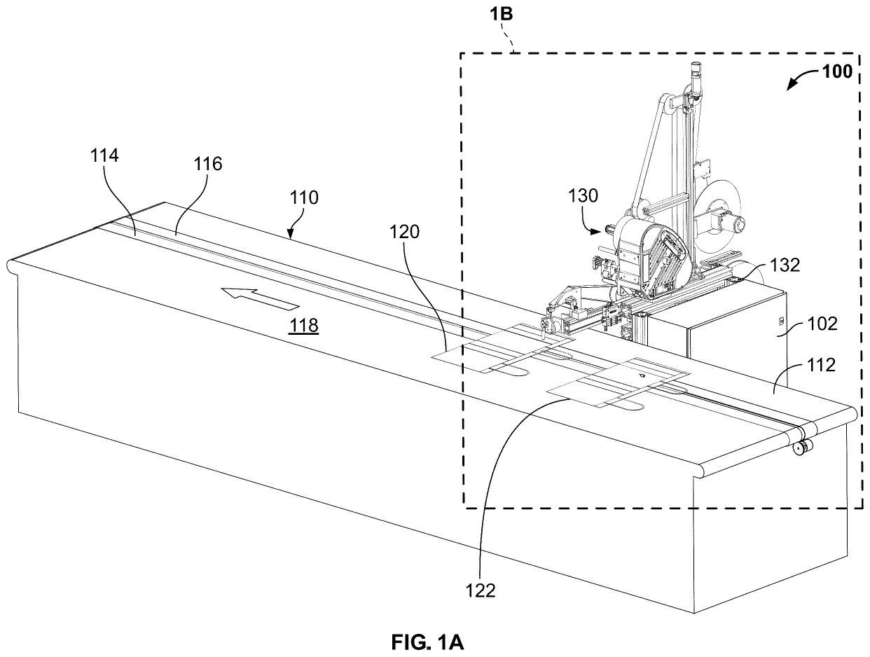

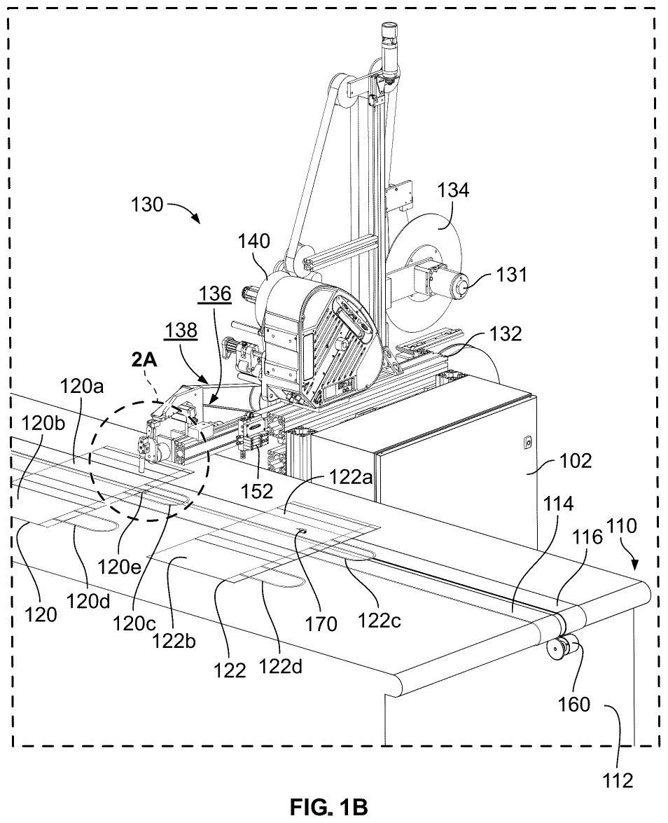

Referring to FIG. 1A, a system for automatically placing hang tabs on gifts bags during the bag forming process in accordance with one embodiment of the present invention is shown generally as reference number 100.

System 100 includes a conveyor 110 operable to transport a series of gift bags, such as gift bags 120 and 122, along a conveyance path. As further shown in FIGS. 1A and 1B, conveyor 110 includes a conveyor frame 112 that supports two moveable conveyor belts 114 and 116. Conveyor belts 114 and 116 are operable to move each gift bag in a linear motion under a hang tab applicator 130 in a direction of travel shown as arrow 118 in FIG. 1A. Of course, the conveyor may have a single conveyor belt or more than two conveyor belts in other embodiments.

Referring still to FIGS. 1A and 1B, in this embodiment, hang tab applicator 130 is supported by a support frame 132 positioned adjacent conveyor 110 at a location where a hang tab may be placed on each gift bag before the bag is fully assembled, as described below. Hang tab applicator 130 may be provided as a standalone system for use with conventional bag forming equipment, or bag forming equipment may be designed to include an integrated hang tab applicator. Advantageously, in this embodiment, hang tab applicator 130 has a relatively narrow side-to-side width that allows it to be positioned between other machine parts (guides, frames, etc.) of the bag forming equipment.

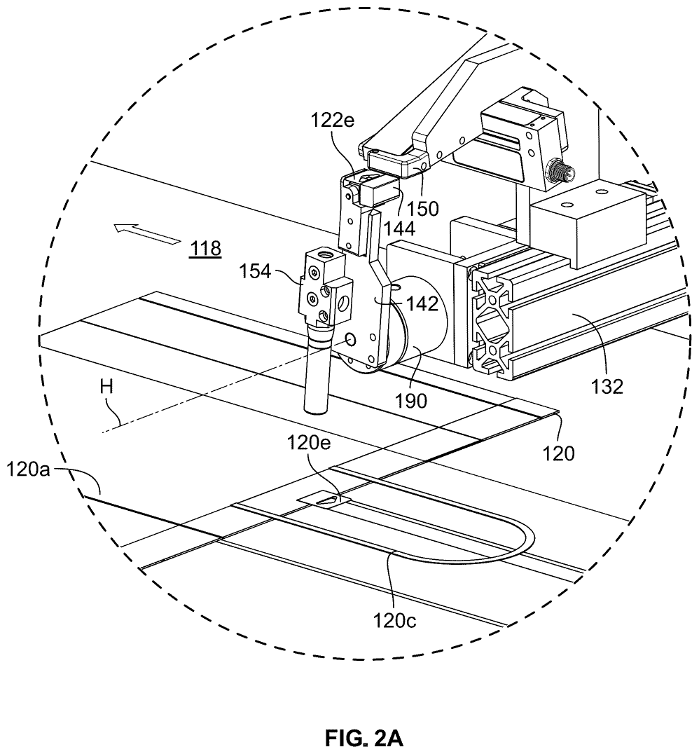

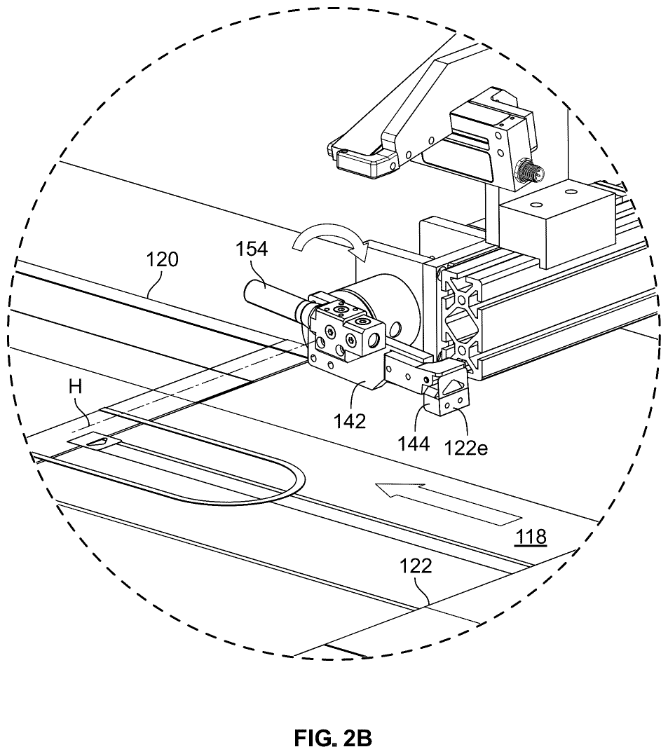

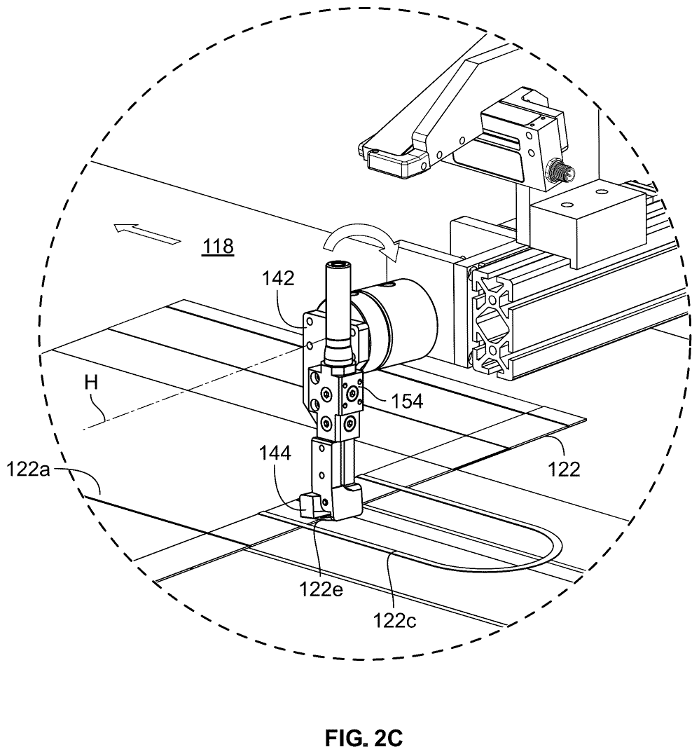

The gift bags on which the hang tabs are to be placed may have a number of different bag configurations. For example, in the embodiment shown in FIGS. 1A and 1B, gift bag 120 includes a plurality of foldable wall segments, including wall segments 120a and 120b, that may be assembled to form an open-ended gift bag. Prior to reaching hang tab applicator 130, the bag forming equipment has attached two rigid handles 120c and 120d to wall segments 120a and 120b, respectively. Hang tab applicator 130 then places a hang tab 120e on gift bag 120—specifically, on what will become an inner surface of wall segment 120a near the bag opening when gift bag 120 is fully assembled. Gift bag 122 has the same configuration as gift bag 120, e.g., gift bag 122 includes wall segments 122a and 122b with attached rigid handles 122c and 122d, respectively. It will be seen that a hang tab 122e (shown in FIGS. 2A-2C) will be placed on gift bag 122 when the bag passes underneath hang tab applicator 130, as described in greater detail below.

It should be understood that gift bags 120 and 122 are merely examples and that other bag sizes and configurations are possible within the scope of the present invention. For example, while gift bags 120 and 122 have rigid handles 120c, 120d, 122c and 122d, other types of handles (including floppy handles) may be used or the gift bags may have no handles at all. Also, while gift bags 120 and 122 have the same height, the gift bags could have different and varying heights within the same production run. Of course, the gift bags preferably have the same width so that the lateral position of hang tab applicator 130 with respect to conveyor 110 may be set for that production run (although different production runs could be used to form bags of different widths simply by adjusting the lateral position of hang tab applicator 130). Further, it will be appreciated that gift bags, as described herein, should be broadly understood to encompass all kinds of foldable packaging, whether fully assembled or not fully assembled, to which hang tabs can be applied in a manufacturing line, including without limitation decorative boxes or collectable product packaging.

The hang tabs that are placed on the gift bags may also have different sizes and configurations. In the embodiment shown in FIGS. 1A and 1B, hang tabs 120e and 122e each comprise an adhesive-backed slot hang tab made of a clear plastic material that may be hung on single-wire or double-wire display hooks. An example of such a hang tab is the slot hang tab available from Do-It Corporation of South Haven, Michigan. Of course, other types of hang tabs may also be used, such as hook hang tabs, round hole hang tabs, fold-up hang tabs, and the like. The hang tabs may also be made of a material other than plastic, such as a biodegradable paper or similar material. It should be understood that any hang tab may be used that includes an adhesive portion (i.e., the portion of the hang tab with an adhesive backing) and a hang hole portion (i.e., the portion of the hang tab with a hang hole or other opening). In this embodiment, it will be seen that each hang tab is placed on a gift bag at an offset position in which (i) the adhesive portion of the hang tab is attached to the gift bag (e.g., along the top edge of a wall segment near the bag opening) and (ii) the hang hole portion of the hang tab extends away from the gift bag to enable the gift bag to be hung on a display hook. An example of applicator equipment that can be used with the system 100 is the XLS 204 sold by Novexx Solutions GmbH. It will be appreciated that other types of applicator or labeler equipment can be used and/or adapted for use with the system 100.

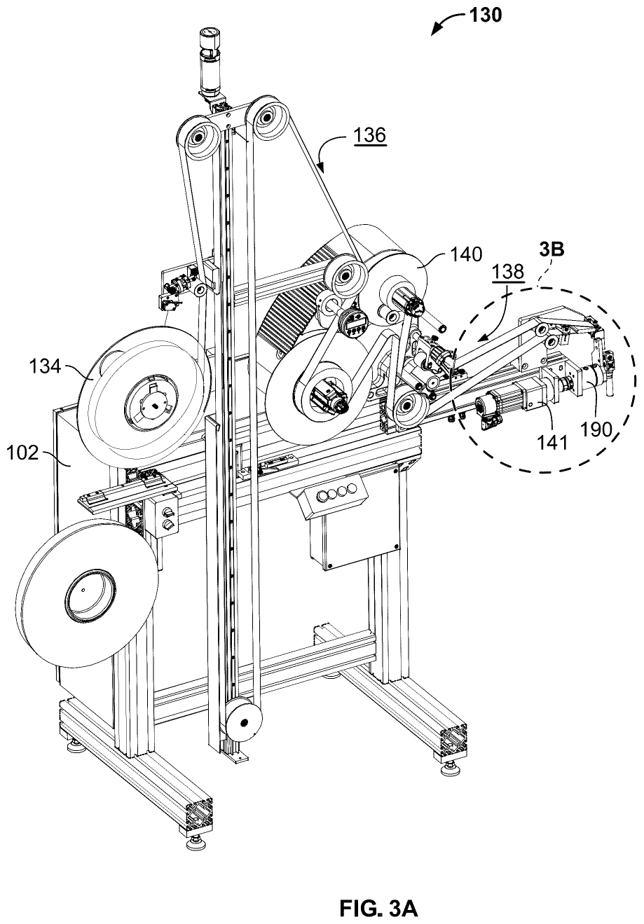

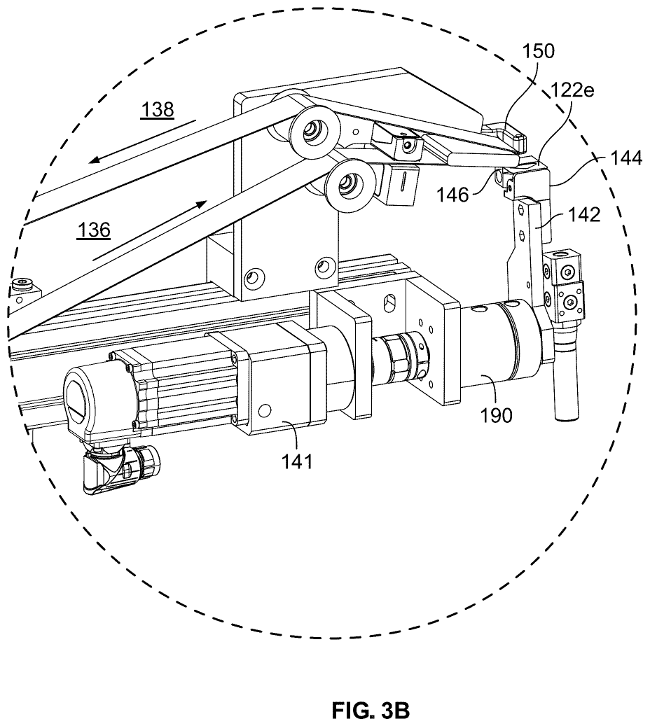

Referring to FIGS. 1B and 3A, the operation of hang tab applicator 130 is controlled by a control system 102, as described in greater detail below with reference to FIGS. 6-8. Hang tab applicator 130 includes a supply reel 134 configured to hold a roll of hang tabs comprising a series of individual hang tabs with their adhesive backs in contact with a backing material. When supply reel 134 is advanced by the control system 102, the roll of hang tabs travels in a first direction along a feed path 136 and, after each individual hang tab is removed from the backing material (as described below), the backing material travels in a second opposing direction along a return path 138 and onto a take-up reel 140.

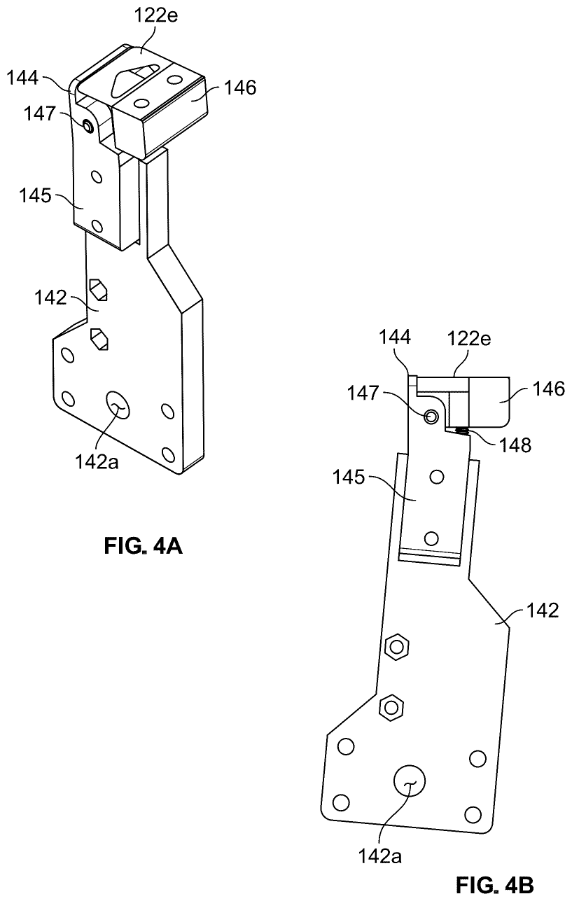

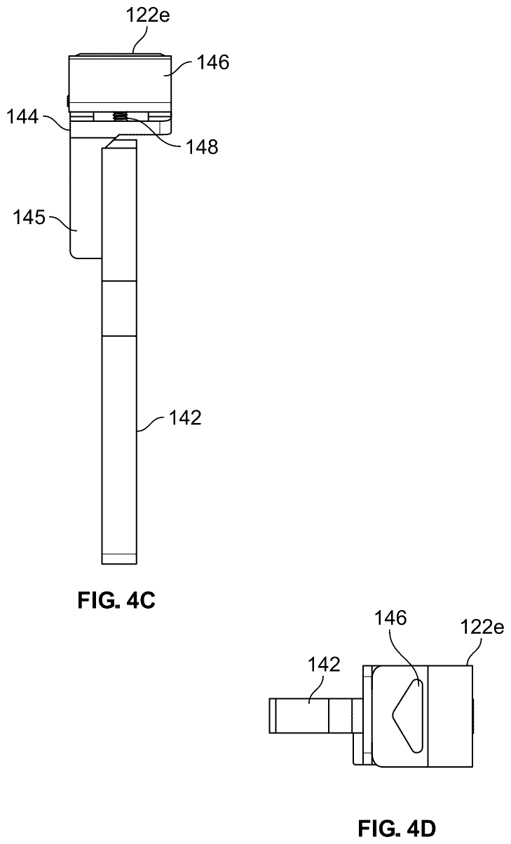

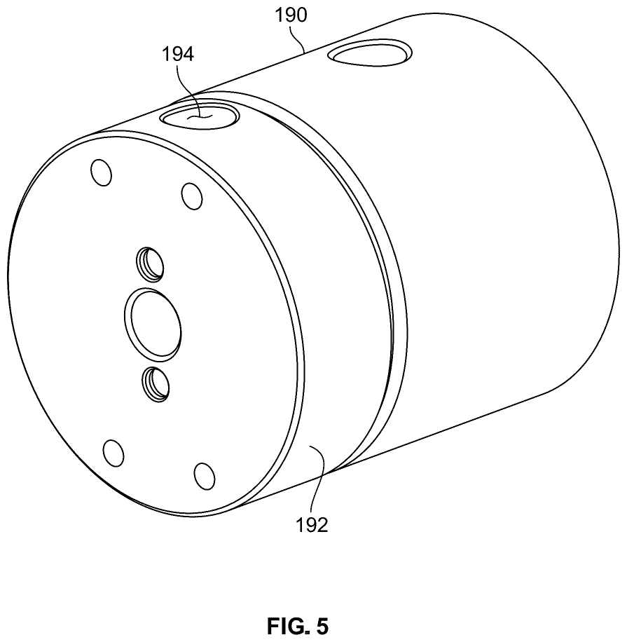

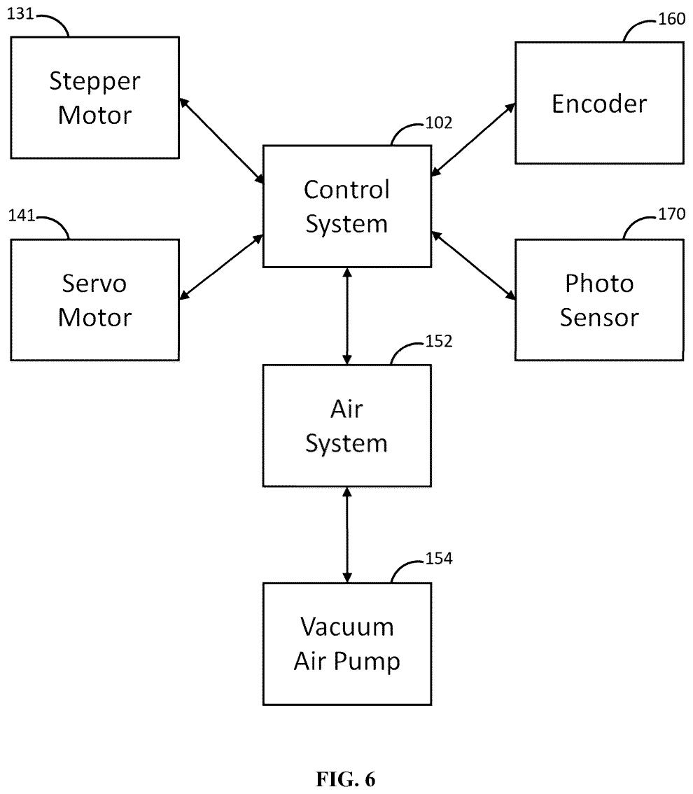

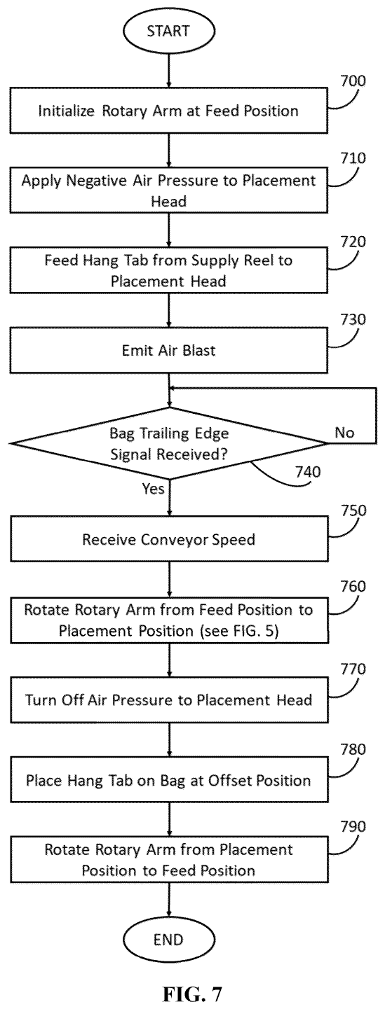

As best shown in FIGS. 2A-3B, hang tab applicator 130 includes a rotary arm 142 driven by a servo motor 141. The rotary arm 142 is configured to rotate between a first feed position and a second placement position. In this embodiment, rotary arm 142 is mounted to a rotary union 190 via an opening 142a in the bottom portion thereof (when viewed as shown in FIGS. 4A and 4B). As shown in FIG. 5, the rotary union includes a rotary bearing 192 that supports rotary arm 142 for the rotary motion. Referring again to FIGS. 2A-2C, rotary arm 142 rotates about a horizontal axis H that is oriented transverse to the direction of bag travel shown by arrow 118. As such, rotary arm 142 can rotate clockwise in a vertical rotation plane that is oriented perpendicular to the axis of rotation H. In this embodiment, the first feed position comprises the twelve o'clock position (FIG. 2A) and the second placement position comprises the six o'clock position (FIG. 2C), although other positions may also be used (e.g., the three o'clock position shown in FIG. 2B).

Referring to FIGS. 4A-4D, affixed to rotary arm 142 at a position away from its axis of rotation is a placement head 144. Placement head 144 includes a head mount bracket 145 and a pivoting head 146. As best shown in FIG. 4B, head mount bracket 145 is fixedly attached to rotary arm 142, and head 146 is pivotally attached to head mount bracket 145 via a pin or other suitable connector 147. As also shown in FIG. 4B, placement head 144 also includes a compression spring 148 that is biased to urge head 146 away from head mount bracket 145. It will be seen that head 146 may pivot toward head mount bracket 145 against the bias of compression spring 148 when pressing a hang tab (e.g., hang tab 122e) on a gift bag (e.g., gift bag 122).

Placement head 144 is aligned to accept a hang tab from the roll of hang tabs when rotary arm 142 is in the first feed position. With reference to FIGS. 3A and 3B, the roll of hang tabs is oriented on supply reel 134 so that the individual hang tabs are located on the bottom surface of the backing material when traveling along feed path 136. As best shown in FIGS. 2A and 3B, when the backing material changes direction at the transition from feed path 136 to return path 138, a hang tab peels away from the backing material and an air jet 150 emits an air blast to blow the hang tab down onto the upper surface of placement head 144 (i.e., onto pivoting head 146).

In order to provide proper orientation of the hang tab on the upper surface of placement head 144, feed path 136 (i.e., the path along which the hang tab is fed from the roll of hang tabs onto placement head 144) is generally perpendicular to the rotation plane of rotary arm 142. For example, when viewed as shown in FIG. 2A, hang tab 122e is oriented on the upper surface of placement head 144 such that the hang hole portion of hang tab 122e is on the left side of placement head 144 and the adhesive portion of hang tab 122e is on the right side of placement head 144 (with the adhesive facing upward). It can be appreciated that hang tab 122e will have the proper orientation for placement on gift bag 122 when rotary arm 142 is rotated from the first feed position to the second placement position (FIG. 2C).

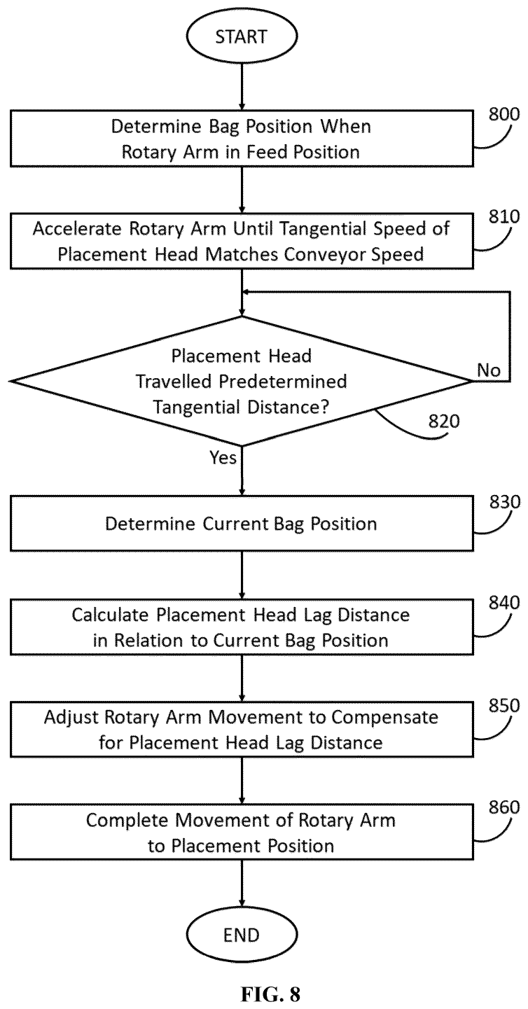

In this embodiment, negative (vacuum) air pressure is applied to pivoting head 146 via vacuum pump 154 through a hose (not shown) when rotary arm 142 is in the first feed position so as to retain the hang tab on placement head 144 in the feed location until a gift bag is detected on conveyor 110. Of course, the hang tab will rest on the upper surface of placement head 144 (i.e., on pivoting head 146) due to gravity even if hang tab applicator 130 is powered down and the negative air pressure is no longer retaining the hang tab on placement head 144. When the control system 102 detects a gift bag on conveyor 110, the negative air pressure is continued to be applied to pivoting head 146 as rotary arm 142 rotates from the first feed position (e.g., FIG. 2A) to the second placement position (e.g., FIG. 2C). When rotary arm 142 reaches the second placement position, the negative air pressure applied to placement head 144 is suspended so as to release the hang tab for placement on the gift bag. In this embodiment, placement head 144 is configured to press the hang tab on the gift bag, as described below. In other embodiments, positive air pressure may be applied to pivoting head 146 to blow the hang tab down onto the gift bag. It will be appreciated that in such embodiments, the pivoting head 146 can be operatively coupled to an air system 152 (best shown in FIG. 1B) to provide for positive blasts of air in addition to the negative air pressure. It is contemplated the air system 152 can be an air valve manifold assembly with solenoid-actuated valves, such as the VTUG valve manifold sold by Festo Corporation, or any other equipment suitable for the functions described herein and any other pneumatic features in the system 100. For example, the air system 152 may have a first solenoid-actuated valve for controlling the supply of air to the air jet 150 (FIG. 3B), a second solenoid-actuated valve for controlling the supply of air to the vacuum pump 154, and a third solenoid-actuated valve for controlling air pressure to operate a clamp in an unwind system of the hang tab applicator 130. The timing for rotation of rotary arm 142 from the first feed positon to the second placement position is determined by the control system 102, as described below in connection with FIG. 8.

As noted above, rotary arm 142 is mounted to a rotary union 190. As shown in FIG. 5, this rotary union 190 includes a flow port 194 that provides a path to supply high pressure air from the air system 152 to the vacuum pump 154 mounted on rotary arm 142 (as shown in FIGS. 2A-2C). When supplied with high pressure air, the vacuum pump 154 applies the negative air pressure to pivoting head 146, as described above. It should be understood that the configuration of the rotary union enables rotary arm 142 to rotate through multiple clockwise rotations without winding up pneumatic air hoses (not shown) connected to the vacuum pump 154.

Referring to FIG. 1B, system 100 also includes an encoder 160 with a wheel riding on conveyor belt 116 of conveyor 110. Of course, the wheel of encoder 160 could alternatively ride on conveyor belt 114. Encoder 160 is configured to generate a signal indicative of the linear speed of conveyor 110 (which is also the linear speed of each gift bag transported on conveyor 110) and transmit such signal to the control system 102. It will be seen that the control system 102 is configured to control rotary arm 142 so that the tangential speed of placement head 144 substantially matches the linear speed of conveyor 110 at the point when the hang tab first makes contact with the gift bag—i.e., the hang tab and gift bag will be travelling at substantially the same speed and in the same direction when rotary arm 142 reaches the second placement position.

System 100 also includes a photo sensor 170 located upstream of hang tab applicator 130. In this embodiment, photo sensor 170 is mounted below the gap between conveyor belts 114 and 116 of conveyor 110 and is configured to detect each gift bag as it passes over photo sensor 170 during transport on conveyor 110. Of course, photo sensor 170 may be mounted at any position that enables detection of each gift bag as it passes by photo sensor 170 during transport on conveyor 110, such as any position adjacent a side of conveyor 110.

In this embodiment, photo sensor 170 is configured to send a signal to the control system 102 upon detection of the trailing edge of each gift bag as it passes by photo sensor 170 during transport on conveyor 110. A trailing edge detection signal is used in this case because the hang tab will be placed on the trailing edge of the gift bag. For example, it can be seen in FIG. 1B that hang tab 120e has been placed on what will become an inner surface of wall segment 120a near the bag opening when gift bag 120 is fully assembled. In other embodiments, photo sensor 170 may detect the leading edge of each gift bag, e.g., in cases where the hang tab is to be placed on the leading edge of the gift bag. Of course, it should be understood that the invention may be adapted to place a hang tab at any desired location on an item (e.g., a fold line) and is not limited to placement on, or detection of, an item's edge.

The control system 102 is configured to time the rotation of rotary arm 142 from the first feed position to the second placement position based on the position of the gift bag on conveyor 110, the linear speed of the conveyor 110, and the desired position for placement of the hang tab on the gift bag. As described in greater detail below in connection with FIG. 8, the control system 102 uses this information to determine when the trailing edge of the gift bag will be located at a target position below hang tab applicator 130 so that rotation of rotary arm 142 can be timed to cause placement head 144 to place the hang tab on the gift bag at a desired offset position in which (i) the adhesive portion of the hang tab is attached to the gift bag and (ii) the hang hole portion of the hang tab extends away from the gift bag to enable the gift bag to be hung on a display hook. This offset position can be best seen with respect to the placement of hang tab 120e on gift bag 120 in FIG. 2A. The matched speed of the hang tab and gift bag at the time of hang tab placement along with accurate registration of the gift bag position enables accurate placement of the hang tab on the gift bag at the desired offset position.

Following placement of the hang tab on the gift bag, rotary arm 142 is accelerated in speed back to the first feed position so that placement head 144 quickly returns to and stops at the hang tab feed location to receive the next hang tab from the roll of hang tabs, as described above. Because the hang tab placement process is triggered by detection of the trailing edge of each gift bag via photo sensor 170, system 100 is able to place hang tabs on bags having different and varying heights and can compensate for variances in bag spacing on conveyor 110 (i.e., the spacing between adjacent bags can vary on conveyor 110). Of course, it will be appreciated that the rotary arm 142 can be driven in other motion patterns (e.g., traveling up and down in a 180-degree arc) without deviating from the processes described herein.

As noted above, a control system 102 (shown in block diagram form in FIG. 6) is provided to control the operation of hang tab applicator 130. Referring further to FIG. 6, it should be understood that the control system 102 communicates with various components of system 100, such as a stepper motor 131 that drives supply reel 134 and take-up reel 140, the servo motor 141 that drives rotary arm 142, the air system 152 that generates the blast of air provided at air jet 150 and that supplies air to the vacuum air pump 154 to generate the negative air pressure provided at pivoting head 146 of placement head 144, encoder 160, photo sensor 170, and any other controlled or sensor components within system 100. While vacuum air pump 154 is shown and described as a pneumatically powered pump controlled by the air system 152, the vacuum air pump 154 may in other embodiments be an electrically powered pump that is actuated based on a control signal received directly from the control system 102. The functionality of the control software implemented by the control system will be described in connection with the flow charts shown in FIG. 7.

First, in step 700, the control system is initialized and sends a control signal to the servo motor 141 that is operative to move rotary arm 142 to the first feed position. As described above, when rotary arm 142 is in the first feed position, placement head 144 is aligned to accept a hang tab from the roll of hang tabs loaded on supply reel 134. In step 710, the control system activates the vacuum air pump 154 by sending a control signal to the solenoid of the air system 152 that causes the air system 152 to supply air to the vacuum air pump 154. As described above, the vacuum air pump 154 is operative to apply negative air pressure to pivoting head 146 of placement head 144. In step 720, the control system sends a control signal to the stepper motor 131 that is operative to advance supply reel 134. As described above, when supply reel 134 is advanced, the roll of hang tabs travels along feed path 136 and, when the backing material changes direction at the transition from feed path 136 to return path 138, a hang tab peels away from the backing material. In step 730, the control system sends a control signal to the air system 152 operative to activate air jet 150 to emit an air blast to blow the hang tab down onto the upper surface of placement head 144 (i.e., onto pivoting head 146). The backing material then travels along return path 138 and eventually onto take-up reel 140.

In step 740, the control system determines if a signal has been received from photo sensor 170 indicating the presence of a gift bag on conveyor 110. In this embodiment, photo sensor 170 generates a signal in response to detection of the trailing edge of a gift bag, and the control system detects the presence of the bag based on this detection signal. If a detection signal has not been received, the process returns to step 740. However, if a detection signal has been received, in step 750, the control system receives a signal from encoder 160 that includes information indicative of the linear speed of conveyor 110.

In step 760, the control system sends a control signal to the servo motor 141 that is operative to rotate rotary arm 142 from the first feed position to the second placement position. The timing of such rotation is based on the position of the gift bag on conveyor 110, the linear speed of the conveyor 110, and the desired position for placement of the hang tab on the gift bag. For example, in this embodiment, the control system calculates when the trailing edge of the gift bag will be located at a target position below hang tab applicator 130 so that rotation of rotary arm 142 can be timed to cause placement head 144 to place the hang tab on the gift bag at a desired offset position in which (i) the adhesive portion of the hang tab is attached to the gift bag and (ii) the hang hole portion of the hang tab extends away from the gift bag to enable the gift bag to be hung on a display hook.

An exemplary process performed by the control system to determine the timing for rotation of rotary arm 142 from the first feed position to the second placement position is shown in FIG. 8. For purposes of this example, it should be understood that the gift bag must travel on conveyor 110 from the position where it passes by photo sensor 170 (which is considered reference position 0) to the target position where the hang tab first contacts the gift bag (which is considered to be reference position X). For example, if photo sensor 170 is located 14 inches from the target position, then X=14 inches. It should be noted that the scaling of encoder 160 is such that its position value represents inches of travel of the gift bag on conveyor 110.

In step 800, when rotary arm 142 is in the first feed position, the control system sets the start position of the gift bag to the position value of encoder 160 at the time that the detection signal is received from photo sensor 170. In this case, the position value of encoder 160 is transmitted to the control system in step 750. In step 810, the control system sends a control signal to the servo motor 141 that is operative to start the rotation of rotary arm 142 so that it accelerates from the stopped position to a speed at which the tangential speed of placement head 144 matches the linear speed of conveyor 110 (i.e., the speed that the gift bag is traveling). Rotary arm 142 then continues to move electronically geared to the gift bag travel speed.

In step 820, the control system determines whether placement head 144 has tangentially traveled a predetermined distance Y, where Y is a value less than X. For example, if X is 14 inches, Y may be 6 inches. If not, the process returns to step 820. When placement head 144 has tangentially travelled distance Y, the process proceeds to step 830. It should be understood that the value of Y should be chosen so that rotary arm 142 has sufficient time to accelerate to the gift bag travel speed before placement head 144 has tangentially travelled distance Y.

In step 830, the control system determines the current position of the gift bag on conveyor 110. To do so, the control system receives the current position value of encoder 160 (i.e., the position value when placement head 144 has tangentially travelled distance Y) and subtracts the start position value from that current position value (i.e., bag current position=encoder current position-encoder start position). In step 840, the control system calculates the distance by which the position of placement head 144 lags the current position of the gift bag (i.e., placement head lag distance=placement arm current position-bag current position). It should be understood that there will be a lag due to the time required for placement head 144 to accelerate in order to reach the gift bag travel speed.

In step 850, the control system sends a control signal to the servo motor 141 that is operative to adjust the movement of rotary arm 142 to compensate for the lag distance calculated in step 840. It should be understood that the incremental move of rotary arm 142 is made on top of the electronically geared motion so that the position of pivoting head 146 is approximately equal to the position of the gift bag. Then, in step 860, rotary arm 142 continues to move at the geared ratio in which the tangential speed of placement head 144 substantially matches the linear speed of conveyor 110. Thus, it can be appreciated that placement head 144 and the gift bag will both reach distance X at substantially the same time to enable accurate placement of the hang tab on the gift bag at the desired position.

It should be understood that the present invention is not limited to the process described above in connection with FIG. 8 and that other processes may be used to time the rotation of rotary arm 142 from the first feed position to the second placement position.

Referring back to FIG. 7, in step 770, when rotary arm 142 reaches the second placement position, the control system sends a control signal to the air system 152 to deactivate the vacuum air pump 154, which turns off the negative air pressure at the pivoting head 146 of placement head 144. In step 780, the hang tab is placed on the gift bag at the desired position. It should be noted that the hang tab will be travelling at substantially the same speed and in the same direction as the gift bag when the hang tab first contacts the gift bag. In this embodiment, the spring-loaded configuration of placement head 144 enables the hang tab to be pressed on the gift bag—i.e., the head 146 may pivot toward head mount bracket 145 against the bias of compression spring 148 when pressing the hang tab on the gift bag. Of course, in other embodiments in which the placement head is not spring-loaded, positive air pressure may be applied to pivoting head 146 to blow the hang tab down onto the gift bag.

In step 790, the control system sends a control signal to the servo motor 141 that is operative to rotate rotary arm 142 from the second placement position back to the first feed position. Thus, placement head 144 quickly returns to and stops at the hang tab feed location to receive the next hang tab from the roll of hang tabs. It should be understood that the control system will perform steps 710 to 790 for each gift bag in a production run and will provide the required timing functions to enable high-speed placement of hang tabs on gift bags (e.g., 100 or more bags per minute).

It should be understood that the steps shown in FIGS. 7 and 8 and the order in which those steps are performed are not intended to be limiting, and that other process control steps may be implemented within the scope of the present invention. It should also be understood that some of the steps shown in FIGS. 7 and 8 may be performed simultaneously. Thus, one skilled in the art will appreciate that a number of different combinations of process control steps may be used to control the operation of hang tab applicator 130.

### General Information

The description set forth above provides several exemplary embodiments of the inventive subject matter. Although each exemplary embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

The use of any and all examples or exemplary language (e.g., “such as” or “for example”) provided with respect to certain embodiments is intended merely to better describe the invention and does not pose a limitation on the scope of the invention. No language in the description should be construed as indicating any non-claimed element essential to the practice of the invention.

The use of the terms “comprises,” “comprising,” or any other variation thereof, are intended to cover a non-exclusive inclusion, such that a system or method that comprises a list of elements does not include only those elements, but may include other elements not expressly listed or inherent to such system or method.

Finally, while the present invention has been described and illustrated hereinabove with reference to various exemplary embodiments, it should be understood that various modifications could be made to these embodiments without departing from the scope of the invention. Therefore, the present invention is not to be limited to the specific structural configurations or methodologies of the exemplary embodiments, except insofar as such limitations are included in the following claims.

What is claimed and desired to be secured by Letters Patent is as follows:

1. A system for placing hang tabs on gift bags during transport on a conveyor, comprising:
a hang tab applicator comprising a rotary arm with an attached placement head, wherein the rotary arm is configured to rotate between a first position at which a hang tab is fed onto the placement head and a second position at which the placement head places the hang tab on a gift bag; and
a control system configured to control operation of the hang tab applicator so that the rotary arm is timed to rotate from the first position to the second position to cause the placement head to place the hang tab on the gift bag at an offset position in which (i) an adhesive portion of the hang tab is attached to the gift bag and (ii) a hang hole portion of the hang tab extends away from the gift bag to enable the gift bag to be hung on a display hook.

2. The system of claim 1, wherein the hang tab applicator further comprises a supply reel configured to hold a roll of hang tabs, and wherein the control system is configured to control operation of the hang tab applicator so that the supply reel is advanced to feed the hang tab from the roll of hang tabs onto an upper surface of the placement head when the rotary arm is in the first position.

3. The system of claim 1, wherein the rotary arm is configured to rotate in a rotation plane, and wherein the hang tab is fed onto the placement head along a feed path that is generally perpendicular to the rotation plane.

4. The system of claim 1, wherein the placement head comprises a vacuum placement head, and wherein the control system is configured to control operation of the hang tab applicator so that negative air pressure is applied to the placement head as the rotary arm rotates from the first position to the second position so as to retain the hang tab on the placement head.

5. The system of claim 1, wherein the placement head comprises a spring-loaded placement head configured to press the hang tab on the gift bag when the rotary arm is in the second position.

6. The system of claim 5, wherein the spring-loaded placement head comprises (i) a head mount bracket fixedly attached to the rotary arm, (ii) a head pivotally attached to the head mount bracket, and (iii) a compression spring biased to urge the head away from the head mount bracket, wherein the head is configured to pivot toward the head mount bracket against the bias of the compression spring when pressing the hang tab on the gift bag.

7. The system of claim 1, wherein the first position comprises a twelve o'clock position and the second position comprises a six o'clock position.

8. The system of claim 1, further comprising an encoder configured to transmit a signal indicative of a linear speed of the conveyor to the control system, and wherein the control system is configured to control operation of the hang tab applicator so that a tangential speed of the placement head as the hang tab is placed on the gift bag substantially matches the linear speed of the conveyor.

9. The system of claim 8, further comprising a photo sensor positioned adjacent the conveyor at a position upstream of the hang tab applicator, wherein the photo sensor is configured to transmit a detection signal to the control system upon detection of a leading edge or a trailing edge of the gift bag, and wherein the control system is configured to, upon receipt of the detection signal, time the rotation of the rotary arm from the first position to the second position based on the position of the photo sensor and the linear speed of the conveyor.

10. The system of claim 1, wherein the gift bags include a first gift bag and a second gift bag transported in series on the conveyor, wherein the first gift bag has a first height and the second gift bag has a second height, and wherein the first height is different from the second height.

11. The system of claim 1, wherein the gift bags include a first gift bag, a second gift bag, and a third gift bag transported in series on the conveyor, wherein the first gift bag is spaced from the second gift bag by a first distance and the second gift bag is spaced from the third gift bag by a second distance, and wherein the first distance is different from the second distance.

12. A system for placing hang tabs on items during transport on a conveyor, comprising:
a hang tab applicator comprising a rotary arm with an attached placement head, wherein the rotary arm is configured to rotate in a rotation plane between a first position and a second position; and
a control system configured to control operation of the hang tab applicator so that (a) a hang tab is fed onto an upper surface of the placement head along a feed path when the rotary arm is in the first position, wherein the feed path is generally perpendicular to the rotation plane of the rotary arm and (b) the rotary arm is timed to rotate from the first position to the second position to cause the placement head to place the hang tab on an item during transport on the conveyor.

13. The system of claim 12, wherein the placement head comprises a vacuum placement head, and wherein the control system is configured to control operation of the hang tab applicator so that negative air pressure is applied to the placement head as the rotary arm rotates from the first position to the second position so as to retain the hang tab on the placement head.

14. The system of claim 12, wherein the placement head comprises a spring-loaded placement head configured to press the hang tab on the item when the rotary arm is in the second position.

15. The system of claim 14, wherein the spring-loaded placement head comprises (i) a head mount bracket fixedly attached to the rotary arm, (ii) a head pivotally attached to the head mount bracket, and (iii) a compression spring biased to urge the head away from the head mount bracket, wherein the head is configured to pivot toward the head mount bracket against the bias of the compression spring when pressing the hang tab onto the gift bag.

16. The system of claim 12, wherein the first position comprises a twelve o'clock position and the second position comprises a six o'clock position.

17. The system of claim 12, further comprising an encoder configured to transmit a signal indicative of a linear speed of the conveyor to the control system, and wherein the control system is configured to control operation of the hang tab applicator so that a tangential speed of the placement head as the hang tab is placed on the item substantially matches the linear speed of the conveyor.

18. The system of claim 17, further comprising a photo sensor positioned adjacent the conveyor at a position upstream of the hang tab applicator, wherein the photo sensor is configured to transmit a detection signal to the control system upon detection of a portion of the item, and wherein the control system is configured to, upon receipt of the detection signal, time the rotation of the rotary arm from the first position to the second position based on the position of the photo sensor and the linear speed of the conveyor.

19. The system of claim 12, wherein the items include a first item and a second item transported in series on the conveyor, wherein the first item has a first height and the second item has a second height, and wherein the first height is different from the second height.

20. The system of claim 12, wherein the items include a first item, a second item, and a third item transported in series on the conveyor, wherein the first item is spaced from the second item by a first distance and the second item is spaced from the third item by a second distance, and wherein the first distance is different from the second distance.
